(19) United States
(12) Patent Application Publication
(10) Pub. No.: US 2022/0077950 A1
(43) Pub. Date: Mar. 10, 2022

(54) WDM RECEIVER AND METHOD OF OPERATION THEREOF

(71) Applicant: ROCKLEY PHOTONICS LIMITED, Altrincham, Cheshire (GB)

(72) Inventors: Thomas Pierre SCHRANS, Pasadena, CA (US); Andrew George RICKMAN, Altrincham (GB)

(21) Appl. No.: 17/418,669

(22) PCT Filed: Dec. 18, 2019
(86) PCT No.: PCT/EP2019/085934

§ 371 Date: Jun. 25, 2021

Related U.S. Application Data
(60) Provisional application No. 62/786,231, filed on Dec. 28, 2018.

(51) Int. Cl. H04J 14/04; H04J 14/02; H04B 10/67

(52) U.S. Cl. CPC H04J 14/04; H04B 10/67; H04J 14/02

(57) ABSTRACT

A wavelength-division multiplexing, WDM, receiver, comprising: an input waveguide; and a demultiplexer, connected to the input waveguide. The demultiplexer is configured to: demultiplex a signal received from the input waveguide into a plurality of separate signals, one or more of the separate signals having multiple optical modes, and output each of the plurality of separate signals into respective output waveguides, connected to respective output ports of the demultiplexer. At least one output waveguide, configured to carry one of the separate signals having multiple optical modes, is connected to a respective mode rotator, the or each mode rotator being configured to rotate the multiple optical modes of the respective separate signal received therein. The or each mode rotator is connected to a respective waveguide photodiode, configured to generate a photocurrent from the separate signal received from the respective mode rotator.

The present invention relates to a WDM receiver and a method of operation thereof.

Optical receivers supporting wavelength division multiplexing (WDM) contain a wavelength demultiplexer (DeMux) and a series of detectors to convert each wavelength signal into an electrical signal. Typical wavelength demultiplexers are based on arrayed waveguide gratings (AWGs), Echelle gratings, angled multimode interference (MMI) waveguides, and/or Mach-Zehnder interferometers, and are generally designed with single mode waveguides.

The detector in such receivers is typically a photodiode (PD), and can be implanted as either a surface illuminated device or a waveguide device. For higher speed applications, waveguide photodiodes are preferred as they provide lower capacitance than surface illuminated devices. Further, for integrated receivers where the light from the demultiplexer is already in a waveguide, waveguide photodiodes are the more common solution. Waveguide photodiodes generally have a horizontal p-i-n junction when implemented in silicon, by horizontal it is meant that the p and n doped layers are vertical and extend up sidewalls of the junction.

In some applications, like coarse wavelength division multiplexing (CWDM), with wide channel spacing and wide channel width, there is a need for broad/flattened passbands, as output channels need low insertion loss within any given channel but high rejection (and so low crosstalk) from adjacent channels. Several approaches have been proposed for this, such as double Gaussian filtering, or tracking of MZIs at the input to the demultiplexer. However these increase insertion loss, have high complexity, and a lower manufacturing yield.

Previous implementations that use surface illuminated photodiodes have used multimode (MM) waveguides for each of the output waveguides of the demultiplexer. This works for demultiplexers that are based on sweeping a beam across the output waveguide as the wavelength changes (e.g. AWG, Echelle, angled MMI) resulting in a wavelength dependent coupling efficiency to the output waveguide. When changing the output waveguide from single mode (SM) to MM, the waveguide is wider, and so the moving spot will couple to the MM waveguide for a larger wavelength range, with a flatter coupling efficiency, but will still have a sharp rejection fall off as the spot crosses over the edge of the waveguide.

Those demultiplexers with MM output waveguides work well, as long as all of the optical circuitry following the demultiplexer performs to the requirements for multiple modes propagating in the waveguides at any time. For example, by implementing a surface illuminated photodiode that usually has a wide enough active area to absorb all of the optical modes.

As multiplexers that sweep the spot with wavelength sweep in the horizontal direction, the higher order modes that are created are referred to as horizontal higher order modes. These can have multiple peaks in the horizontal axis (in-plane relative to the photonic integrated circuit, PIC) but are single peaked in the vertical axis (perpendicular to the PIC).

For waveguide photodiodes with horizontal junctions, the horizontal edges of the waveguide experience larger optical losses due to the presence of a thin layer of doping at the edges to create the p-i-n junction. This loss does not create any usable photocurrent. As the higher order modes have a larger fraction of their power near the waveguide edges, they will generate less photocurrent, and hence the photodiode will have a responsivity profile which is strongly dependent on wavelength. This negates the benefit of the flattening of wavelength response provided by the MM waveguides.

Therefore, the best silicon based photodiodes (e.g. a waveguide with horizontal junctions) do not work well with the flattened wavelength response provided by a demultiplexer with one or more MM output waveguides. The photodiodes would need redesigning, and this would result in a loss in performance.

Accordingly, in a first aspect, embodiments of the present invention provide a wavelength-division multiplexing, WDM, receiver, comprising:
an input waveguide;
a demultiplexer, connected to the input waveguide, and configured to:
   demultiplex a signal received from the input waveguide into a plurality of separate signals, one or more of the separate signals having multiple optical modes, and
   output each of the plurality of separate signals into respective output waveguides, connected to respective output ports of the demultiplexer;
wherein at least one output waveguide, configured to carry one of the separate signals having multiple optical modes, is connected to a respective mode rotator, the or each mode rotator being configured to rotate the multiple optical modes of the respective separate signal received therein; and
wherein the or each mode rotator is connected to a respective waveguide photodiode, configured to generate a photocurrent from the separate signal received from the respective mode rotator.

Such a WDM receiver displays enhanced performance, and a flatter wavelength response.

The WDM receiver may have any one or, to the extent that they are compatible, any combination of the following optional features.

At least one of the plurality of separate signals may have multiple horizontal optical modes, the or each mode rotator may be configured to rotate the multiple horizontal modes into multiple vertical modes, and the or each waveguide photodiode may comprise a horizontal semiconductor junction.

At least one of the plurality of separate signals may have multiple vertical modes, the or each mode rotator may be configured to rotate the multiple vertical optical modes into multiple horizontal optical modes, and the or each waveguide photodiode may comprise a vertical semiconductor junction.

The WDM receiver may further comprise an intermediate waveguide, located between at least one mode rotator and a respective waveguide photodiode, and the intermediate waveguide may have a width, measured in a direction perpendicular to a guiding direction of the intermediate waveguide, which narrows along a length parallel to the guiding direction of the intermediate waveguide. The WDM receiver may further comprise an intermediate waveguide, located between the or each of the mode rotators and the corresponding waveguide photodiode, each intermediate waveguide may have a width, measured in a direction perpendicular to a guiding direction of the respective intermediate waveguide, which narrows along a length parallel to the guiding direction of the respective intermediate waveguide, so as to reduce a spot-size of the multiple optical modes transmitted therethrough.

Each waveguide photodiode may be provided on a silicon-on-insulator wafer, and comprise a rib or ridge waveguide including one or more doped regions. Each rib or ridge waveguide may be formed of germanium. Each waveguide photodiode may have a first doped region and a second doped region, separated by an intrinsic region. The first doped region of each waveguide photodiode may comprise a lower doped region and an upper doped region, and the lower doped region may contain dopants at a higher concentration than the upper doped region. Each waveguide photodiode may comprise a first electrode in electrical contact with the first doped region, and a second electrode in electrical contact with the second doped region. The first electrode may be in electrical contact with the lower doped region of the first doped region, and the second electrode may be in electrical contact with the lower doped region of the second doped region. The lower doped region, having a higher doping concentration than the upper doped region, is located spatially below the upper doped region.

The demultiplexer may be any one of: an arrayed waveguide grating, an Echelle grating, an angled multimode interference demultiplexer, or a Mach-Zehnder interferometer.

All of the separate signals may have multiple optical modes, all of the output waveguides may be connected to respective rotators, and all of the mode rotators may be connected to a respective waveguide photodiode.

In a second aspect, embodiments of the present invention provide a method of operating a wavelength-division multiplexing, WDM, receiver, comprising the steps of:
receiving, at an input waveguide, a signal;
providing the received signal to a demultiplexer;
demultiplexing, by the demultiplexer, the received signal into a plurality of separate signals, one or more of the separate signals having multiple optical modes;
outputting each of the plurality of separate signals into respective output waveguides, which are connected to respective output ports of the demultiplexer;
in at least one output waveguide, which is carrying one of the separate signals having multiple optical modes, using a mode rotator to rotate the multiple optical modes of the respective signals received therein; and
provide the rotated respective signal to a waveguide photodiode which generates a photocurrent therefrom.

Such a method results in a greater degree of photocurrent being generated, and the receiver has a flatter wavelength response.

The method may have any one or, to the extent that they are compatible, any combination of the following optional features.

At least one of the plurality of separate signals may have multiple horizontal optical modes, the or each mode rotator may rotate the multiple horizontal modes into multiple vertical optical modes, and the or each waveguide photodiode may comprise a horizontal semiconductor junction.

At least one of the plurality of separate signals may have multiple vertical modes, the or each mode rotator may be configured to rotate the multiple vertical modes into multiple horizontal modes, and the or each waveguide photodiode may comprise a vertical semiconductor junction.

The receiver may further comprise an intermediate waveguide, located between at least one mode rotator and a respective waveguide photodiode, the intermediate waveguide may have a width, as measured in a direction perpendicular to a guiding direction of the intermediate waveguide, which narrows along a length parallel to the guiding direction of the intermediate waveguide, so as to reduce a spot-size of the multiple optical modes transmitted therethrough.

Each waveguide photodiode may be provided on a silicon-on-insulator wafer, and comprise a rib or ridge waveguide, including one or more doped regions. Each rib or ridge may be formed of germanium. Each waveguide photodiode may have a first doped region and a second doped region, separated by an intrinsic region. The first doped region of each waveguide photodiode may comprise a lower doped region and an upper doped region, and the lower doped region may contain dopants at a higher concentration than the upper doped region. The second doped region of each waveguide photodiode may comprise a lower doped region and an upper doped region, and the lower doped region may contain dopants at a higher concentration than the upper doped region. Each waveguide photodiode may further comprise a first electrode in contact with the first doped region, and a second electrode in electrical contact with the second doped region. The first electrode may be in electrical contact with the lower doped region of the first doped region, and the second electrode may be in electrical contact with the lower doped region of the second doped region.

The demultiplexer may be nay one of: an arrayed waveguide grating, an Echelle grating, an angled multimode interference demultiplexer, or a Mach-Zehnder interferometer.

All of the separate signals may have multiple optical modes, all of the output waveguides may be connected to respective mode rotators, and all mode rotators may be connected to a respective waveguide photodiode.

Further aspects of the present invention provide: a computer program comprising code which, when run on a computer, causes the computer to perform the method of the second aspect; a computer readable medium storing a computer program comprising code which, when run on a computer, causes the computer to perform the method of the second aspect; and a computer system programmed to perform the method of the second aspect.

Embodiments of the invention will now be described by way of example with reference to the accompanying drawings in which:

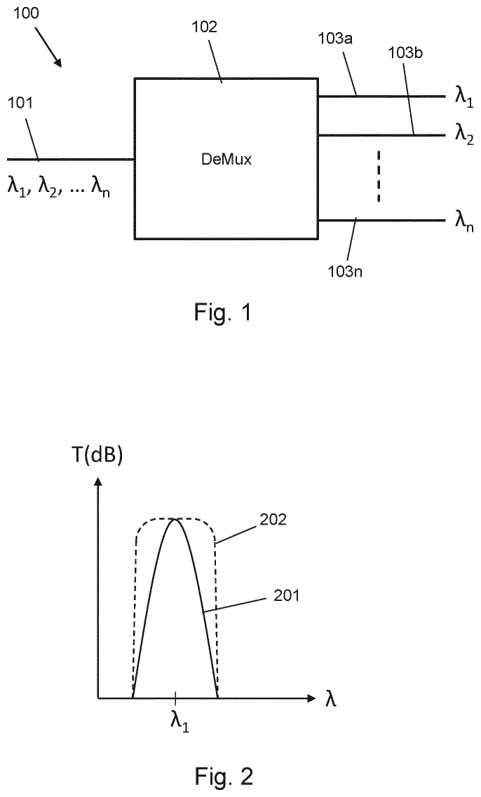

FIG. 1 shows a schematic view of a WDM receiver;

FIG. 2 shows a plot of transmission (dB) against wavelength for an output of the demultiplexer in the WDM receiver;

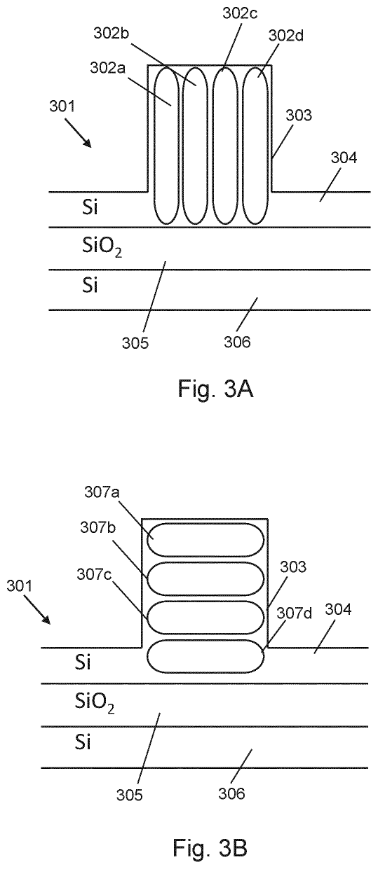

FIGS. 3A and 3B show light in a higher order horizontal mode and a higher order vertical mode respectively;

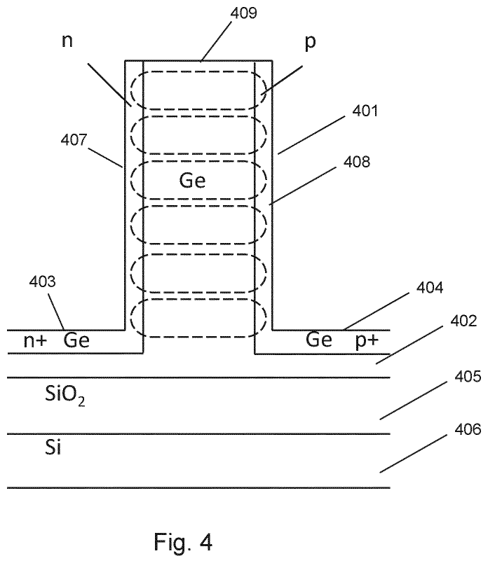

FIG. 4 shows a structure of a waveguide photodiode; and

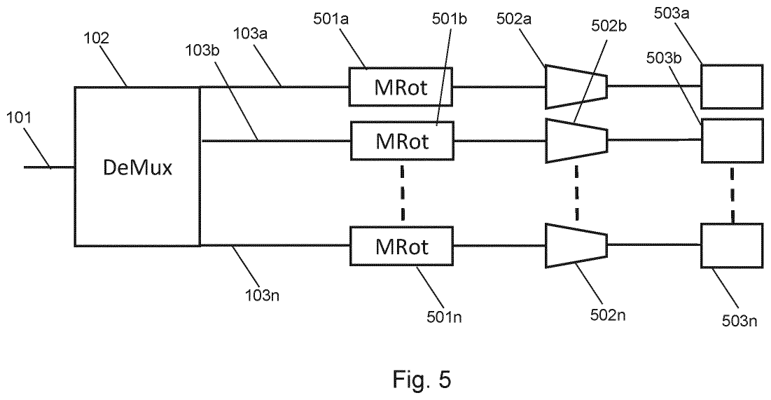

FIG. 5 shows a detailed schematic view of a WDM receiver.

Aspects and embodiments of the present invention will now be discussed with reference to the accompanying figures. Further aspects and embodiments will be apparent to those skilled in the art.

FIG. 1 shows a schematic view of a WDM receiver 100. In this example, wavelength multiplexed signal: λ₁, λ₂, . . . , λₙ is provided through a single mode input waveguide 101 to a demultiplexer 102. The demultiplexer demultiplexers the multiplexed signal, and provides separate signals to n output waveguides 103a-103n. Each output waveguide is configured to carry a wavelength-dependent portion of the multiplexed signal. One or more of the output waveguides are configured to carry multiple optical modes. Preferably, all of the output waveguides are configured to carry multiple optical modes. The demultiplexer may be, for example, an Echelle grating, arrayed waveguide grating, MZI, or angled MMI.

FIG. 2 shows a plot of transmission (dB) against wavelength for an output of the demultiplexer in the WDM receiver. The solid line 201 illustrates the transmission profile for a single mode output waveguide, which is Gaussian in shape and includes a maxima. The dashed line 202 illustrates the transmission profile for a multiple mode output waveguide, in contrast to the single mode output waveguide, the multiple mode output waveguide has a broader and flatter wavelength response than the single mode output waveguide.

FIGS. 3A and 3B show light in a higher order horizontal mode and a higher order vertical mode respectively. As discussed previously, the output waveguide 301 carries a multiple mode optical signal. In this example, the optical signal is in a higher order horizontal mode including peaks 302a-302d, which is supported within a waveguide ridge 303. This horizontal mode can be considered as an array of horizontally spaced peak in amplitudes. The ridge is formed of an upstanding region of silicon layer 304, and bounded on a lower side by buried oxide layer 305 (formed, in this example, of SiO₂). The buried oxide layer is sandwiched between the silicon layer 304 and silicon substrate 306.

As discussed previously, the optical signal is then provided to a mode rotator, and the optical mode is rotated by 90°. Therefore, as shown in FIG. 3B, the optical signal now comprise a higher order vertical mode comprising a plurality of peaks: 307a-307d. This vertical mode can be considered as an array of vertically spaced peaks in amplitude

In another embodiment, not shown, the operation is reversed and so light is rotated from a multiple vertical mode state to a multiple horizontal mode state.

FIG. 4 shows a structure of a waveguide photodiode 400 of the type used in the WDM receiver. Broadly, the photodiode comprises a waveguide ridge 401 which projects from a germanium slab 403 and 404 and a silicon slab 402. The silicon slab sits atop a buried oxide layer 405, in this example SiO₂, which is sandwiched between the silicon slab and a silicon substrate 406. The manufacturing process broadly comprises: (i) providing a silicon-on-insulator wafer; (ii) thinning a silicon device layer; (iii) depositing bulk germanium of a uniform thickness; (iv) forming the waveguide ridge by etching adjacent portions, leaving a slab; and (v) providing one or more electrode contacts.

The ridge 401 is, in this example, formed of germanium. The ridge includes doped sidewalls 407 and 408 separated by an intrinsic germanium region 409. This formed a horizontal p-i-n junction of the type referred to previously. The photodiode also includes a heavily n+ doped region 403, and a heavily p+ doped region 404. These regions are respectively connected to electrodes, and the higher doping concentration decreases the series resistance of the photodiode.

The ridge is preferably relatively narrow, for example at least 0.5 μm and no more than 1.5 μm. By providing such a ridge, the transit time is kept short and so the resulting photodiode can be operated at higher speeds. As such, by providing an optical signal with multiple vertical modes, a greater number of modes can be supported by the ridge waveguide than if the optical signal was in multiple horizontal modes. Correspondingly, the wavelength-transmission profile is flatter as has been discussed previously. Further, the bulk of each of the optical signals are located within a central portion of the ridge. This negates the effect the doped regions have on the optical signal as a whole, as no particular mode sits chiefly over either of the doped regions.

In an alternative example, not shown, the photodiode structure has a vertical junction. Rather than doped sidewalls, the ridge has upper and lower doped regions which laterally extend across the ridge and are spaced by an intrinsic region. In this example, the optical signal preferably comprises multiple horizontal modes which each extend from an upper portion of the ridge to a lower portion. Again, this ensures that no one optical mode is predominantly located either of the doped regions and so the optical losses due to these doped regions are spread over the optical signal as a whole.

FIG. 5 shows a detailed schematic view of a WDM receiver. As before, an input waveguide 101 provides a wavelength division multiplexed signal to demultiplexer 102. After demultiplexing, a plurality of separate signals are provided to respective output waveguides 103a-103n. Along each output waveguide is a mode rotator 501a-501n, which performs the mode rotation discussed above.

After rotation, each output waveguide tapers in a respective taper region 502-502n from a first width to a second width (the second width being smaller than the first width). After the tapered region, the output waveguide couples to a respective waveguide photodiode 400a-400n of the type discussed previously.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A wavelength-division multiplexing, WDM, receiver, comprising:
an input waveguide;
a demultiplexer, connected to the input waveguide, and configured to:
demultiplex a signal received from the input waveguide into a plurality of separate signals, one or more of the separate signals having multiple optical modes, and
output each of the plurality of separate signals into respective output waveguides, connected to respective output ports of the demultiplexer;
wherein at least one output waveguide, configured to carry one of the separate signals having multiple optical modes, is connected to a respective mode rotator, the or each mode rotator being configured to rotate the multiple optical modes of the respective separate signal received therein; and
wherein the or each mode rotator is connected to a respective waveguide photodiode, configured to generate a photocurrent from the separate signal received from the respective mode rotator.

2. The wavelength-division multiplexing receiver of claim 1, wherein at least one of the plurality of separate signals has multiple horizontal optical modes, the or each mode rotator is configured to rotate the multiple horizontal optical modes into multiple vertical modes, and wherein the or each waveguide photodiode comprises a horizontal semiconductor junction.

3. The wavelength-division multiplexing receiver of claim 1, wherein at least one of the plurality of separate signals has multiple vertical optical modes, the or each mode rotator is configured rotate the multiple vertical optical modes into multiple horizontal optical modes, and wherein the or each waveguide photodiode comprises a vertical semiconductor junction.

4. The wavelength-division multiplexing receiver of claim 1, further comprising an intermediate waveguide, located between at least one mode rotator and a respective waveguide photodiode, wherein the intermediate waveguide has a width, measured in a direction perpendicular to a guiding direction of the intermediate waveguide, which narrows along a length parallel to the guiding direction of the intermediate waveguide.

5. The wavelength-division multiplexing receiver of claim 4, further comprising an intermediate waveguide, located between the or each of the mode rotators and the corresponding waveguide photodiode, wherein each intermediate waveguide has a width, measured in a direction perpendicular to a guiding direction of the respective intermediate waveguide, which narrows along a length parallel to the guiding direction of the respective intermediate waveguide, so as to reduce a spot-size of the multiple optical modes transmitted therethrough.

6. The wavelength-division multiplexing receiver of claim 1, wherein each waveguide photodiode is provided on a silicon-on-insulator wafer, and comprises a rib or ridge waveguide including one or more doped regions.

7. The wavelength-division multiplexing receiver of claim 6, wherein each rib or ridge waveguide is formed of germanium.

8. The wavelength-division multiplexing receiver of claim 6, wherein each waveguide photodiode has a first doped region and a second doped region, separated by an intrinsic region.

9. The wavelength-division multiplexing receiver of claim 8, wherein the first doped region of each waveguide photodiode comprises a lower doped region and an upper doped region, and wherein the lower doped region contains dopants at a higher concentration than the upper doped region.

10. The wavelength-division multiplexing receiver of claim 9, wherein the second doped region of each waveguide photodiode comprises a lower doped region and an upper doped region, and wherein the lower doped region contains dopants at a higher concentration than the upper doped region.

11. The wavelength-division multiplexing receiver of claim 10, wherein each waveguide photodiode further comprises a first electrode in electrical contact with the first doped region, and a second electrode in electrical contact with the second doped region.

12. The wavelength-division multiplexing receiver of claim 11, wherein the first electrode is in electrical contact with the lower doped region of the first doped region and the second electrode is in electrical contact with the lower doped region of the second doped region.

13. The wavelength-division multiplexing receiver of claim 1, wherein the demultiplexer is any one of: an arrayed waveguide grating, an Echelle grating, an angled multimode interference demultiplexer, or a Mach-Zehnder interferometer.

14. The wavelength-division multiplexing receiver of claim 1, wherein all of the separate signals have multiple optical modes, all of the output waveguides are connected to respective mode rotators, and all mode rotators are connected to a respective waveguide photodiode.

15. A method of operating a wavelength-division multiplexing, WDM, receiver, comprising the steps of:
receiving, at an input waveguide, a signal;
providing the received signal to a demultiplexer;
demultiplexing, by the demultiplexer, the received signal into a plurality of separate signals, one or more of the separate signals having multiple optical modes;
outputting each of the plurality of separate signals into respective output waveguides, which are connected to respective output ports of the demultiplexer;
in at least one output waveguide, which is carrying one of the separate signals having multiple optical modes, using a mode rotator to rotate the multiple optical modes of the respective signal received therein; and
provide the rotated respective signal to a waveguide photodiode which generates a photocurrent therefrom.

16. The method of claim 15, wherein at least one of the plurality of separate signals has multiple horizontal optical modes, the or each mode rotator rotates the multiple horizontal optical modes into multiple vertical optical modes, and wherein the or each waveguide photodiode comprises a horizontal semiconductor junction.

17. The method of claim 15, wherein at least one of the plurality of separate signals has multiple vertical optical modes, the or each mode rotator is configured to rotate the multiple vertical optical modes into multiple horizontal optical modes, and wherein the or each waveguide photodiode comprises a vertical semiconductor junction.

18. The method of claim 15, wherein the receiver further comprises an intermediate waveguide, located between at least one mode rotator and a respective waveguide photodiode, wherein the intermediate waveguide has a width, measured in a direction perpendicular to a guiding direction of the intermediate waveguide, which narrows along a length parallel to the guiding direction of the intermediate waveguide, so as to reduce a spot-size of the multiple optical modes transmitted therethrough.

19. The method of claim 15, wherein each waveguide photodiode is provided on a silicon-on-insulator wafer, and comprises a rib or ridge waveguide including one or more doped regions.

20. The method of claim 19, wherein each rib or ridge waveguide is formed of germanium.

21-27. (canceled)
